(19) United States
(12) Patent Application Publication
(10) Pub. No.: US 2026/0237321 A1
(43) Pub. Date: Aug. 13, 2026

(54) TOUCH LEARNING DEVICE FOR WIND INSTRUMENTS

(71) Applicant: Nathan Owen Brown, Seattle, WA (US)

(72) Inventor: Nathan Owen Brown, Seattle, WA (US)

(21) Appl. No.: 19/441,413

(22) Filed: Jan. 6, 2026

Related U.S. Application Data
(60) Provisional application No. 63/743,010, filed on Jan. 8, 2025.

(51) Int. Cl. G09B 15/00; G10D 9/00

(52) U.S. Cl. CPC G09B 15/00; G10D 9/00

(57) ABSTRACT

The present invention describes a touch training device for wind instruments including woodwind and brasswind musical instruments that is fastenable to a musical instrument and is adjustable to bring a touch point into contact with the musician's face or body to provide touch sensory feedback to the musician as they play. This touch sensory feedback helps the musician learn how they are using their instrument in relation to their body, feel any unwanted motion or excessive movement during play session, and learn more about how their lips, face, and bone structure help play the instrument.

### TECHNICAL FIELD

The present invention describes a touch training device for wind instruments including woodwind and brasswind musical instruments that is fastenable to a musical instrument and is adjustable to bring a touch point into contact with the musician's face or body to provide touch sensory feedback to the musician as they play. This touch sensory feedback helps the musician learn how they are using their instrument in relation to their body, feel any unwanted motion or excessive movement during play session, and learn more about how their lips, face, and bone structure help play the instrument.

### PRIOR ART

A flute air flow visualization teaching apparatus (U.S. Pat. No. 6,399,867-B1) includes a clip-on arm that holds several small fan blades near a flute lip plate. As the player blows, the fans turn, helping the musician visualise the direction and force of their air flow.

Another common visualization learning tool is an embouchure mirror that mounts to the instrument in such a way that a wind player can view their embouchure working in real time as they play and make fine adjustments to improve their technique.

Visualization tools are helpful for learning but sensory touch feedback tools can help a musician feel how their face and body are acting in relation to the instrument and the musical tones.

The present disclosure describes a training device for learning a woodwind or brasswind musical instrument by providing touch sensory feedback to the player about how they are using or moving their face and body in relationship with the musical instrument.

### TERMS

Various terms used in the present disclosure are described as follows, although such terms may have other descriptions included in the present disclosure.

“Musical Instrument,” “Wind Instrument,” or “Instrument” refers to any portable woodwind or brasswind instrument. For example, saxophone, trumpet, clarinet, flute, oboe, bassoon, etc.

“Mouth Piece” refers to the section of a musical instrument that the player places near their mouth to play the instrument. A complete mouthpiece example from clarinet would include the reed, ligature, and mouthpiece. An example from the bassoon would include the reed and bocal.

“Training Device,” “Learning Aid,” “Touch Learning Device,” or “Touch Learning Aid Device,” refers to any device ancillary to a wind instrument that attaches to the instrument near the mouthpiece to provide touch contact with the player so as to provide sensory input to the musician's body while they play.

### DESCRIPTION

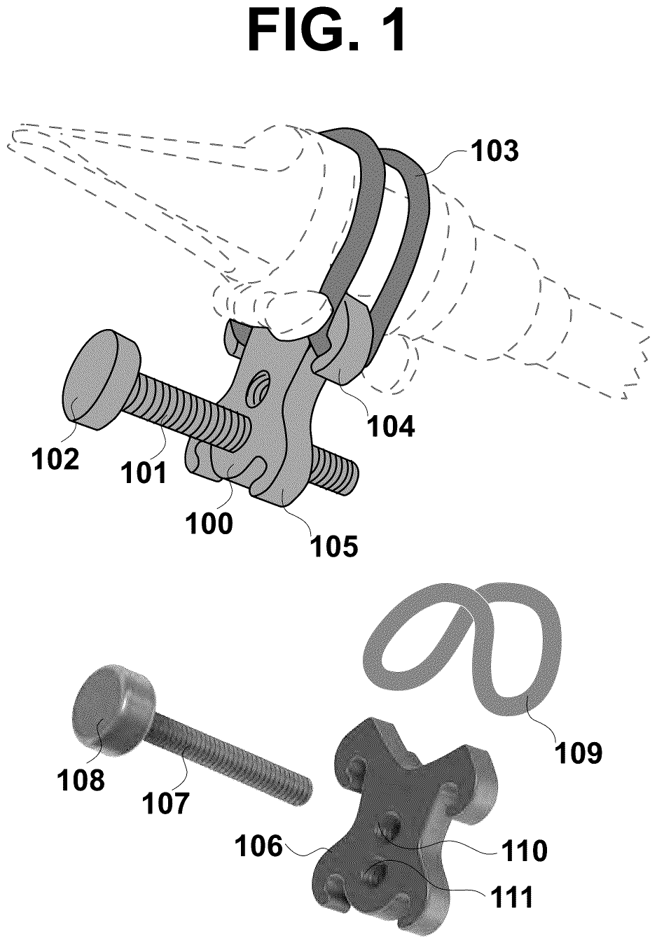

FIG. 1 Shows an embodiment of a training device (drawn with gray color tones) mounted to a saxophone mouthpiece (drawn with dashed lines), and an isolated exploded view of that training device. In this embodiment, the training device has four parts including a brace 100, a screw 101, a touch point 102, and an elastic band 103 made of a looped cord. The elastic band 103 is stretched around the mounting point of the instrument (in this example a saxophone mouthpiece) and looped so the opposing ends of the elastic band 103 are held by brace hooks 104 located at opposing sides of the brace 100. Notice that longer hook options 105 are available if needed to increase the tension hold when mounting the brace against the instrument. In this embodiment use, the brace 100 is set between the two screws of this classic saxophone ligature to increase mounting stability.

Shown at the bottom of FIG. 1 is an isolated and exploded view of the training device, having brace 106, screw 107, touch point 108, and elastic band 109. Notice there are two threaded screw holes 110 and 111 located in the brace 106 which the musician may choose to use for adjusting the placement of the screw 107 in relation to the player and musical instrument. This gives the musician multiple adjustment options to set the touch point 108 in the desired learning position against the musician's face. The steady touch of the training device against the musician's face gives the musician instant bio feedback while they play, helping them notice how they interact with and control the musical instrument. For example, a player feels how much their jaw moves as they play scales across the full range of their instrument, or the player feels how they tilt the instrument in unproductive ways when playing a complex section of music. More than one elastic band 109 may be used with this embodiment to increase fastening strength and stability. More than one touch point 108 may be used with this embodiment by duplicating the screw 107 and touch point 108 then adding that additional screw and touch point into threaded screw holes 110 and 111.

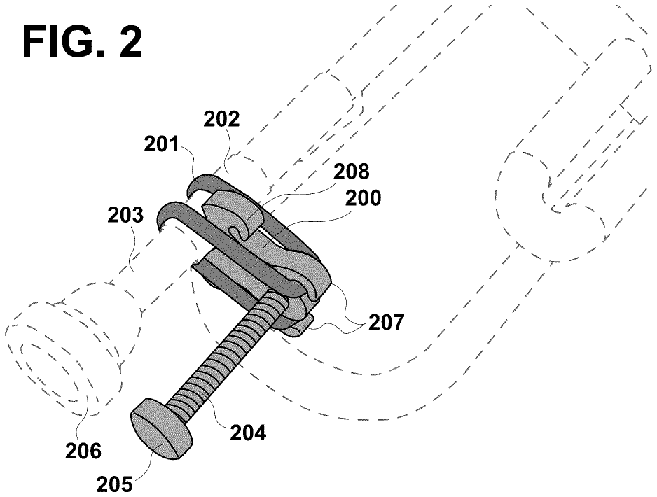

FIG. 2 Shows a training device (drawn with gray color tones) mounted to a trumpet (drawn with dashed lines). In this embodiment, the training device 200 is mounted via looped elastic band 201 to the lead pipe receiver 202 near the mouthpiece shank 203. The screw 204 of the training device has been adjusted to bring a touch point 205 close to the mouthpiece rim 206 so that the touch point 205 can contact the players chin and face as they play the trumpet. This gives the player instant sensory feedback about how they are using their mouth, face, and playing angle. Notice that in this embodiment, the elastic band 201 is stretching further distance into the longest brace hooks 207 rather than the shorter brace hooks 208. This provides tighter mounting of the training device with the small trumpet tube. The various brace hook options 207 and 208 offer the musician adjustment choice for mounting the training device to varied musical parts even as thin as a bassoon bocal or thick as a baritone saxophone mouthpiece.

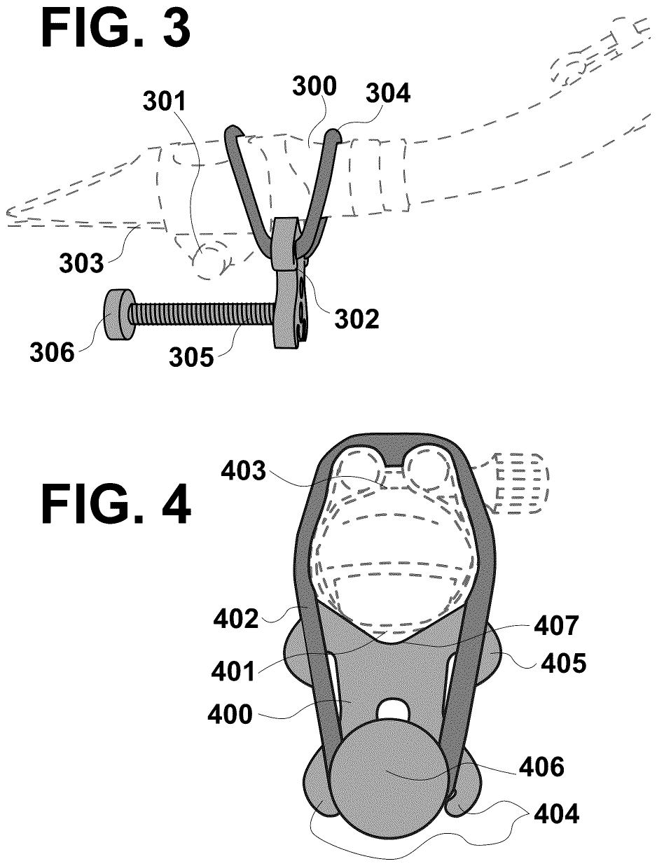

FIG. 3 Shows a side view of a training device (drawn with gray color tones) mounted to a tenor saxophone mouthpiece (drawn with dashed lines). In this example, the tenor saxophone mouthpiece has unevenly rounded shank contours 300 and a bulky single screw ligature 301. Because of the uneven mounting surfaces of this saxophone mouthpiece, the training device brace 302 is mounted against the butt end of the reed 303 that extends past the ligature 301. The elastic band 304 is spread wide across the unevenly rounded shank contours 300 of the mouthpiece to provide stable holding position of the brace 302. Additional elastic bands may be used if extra mounting support is desired. The screw 305 is adjusted to position the touch point 306 near the saxophone player's chin, lips, or face area.

FIG. 4 Shows a front-on “player's view” of the same training device (drawn with gray color tones) mounted against a soprano saxophone mouthpiece and ligature having a bulky top screw (drawn with dashed lines). The training device includes a brace 400 mounted center under the ligature and reed 401. The training device's elastic band 402 is stretched tight around the center top of the mouthpiece and ligature 403 then hooked into the longest brace hooks 404. The shorter brace hooks 405 are not used in this situation because the soprano saxophone mouthpiece is very slender. The touch point 406 has been adjusted via a screw (not visible in this view but visible in all previous figure views). Notice how the concave mounting surface 407 at the top of brace 400 helps the brace position and mount well to the varied surface countours of musical instruments. Multiple concave mounting surface 407 may be included in the brace 400 to improve mechanical hold of the training device 400 against the musical instrument.

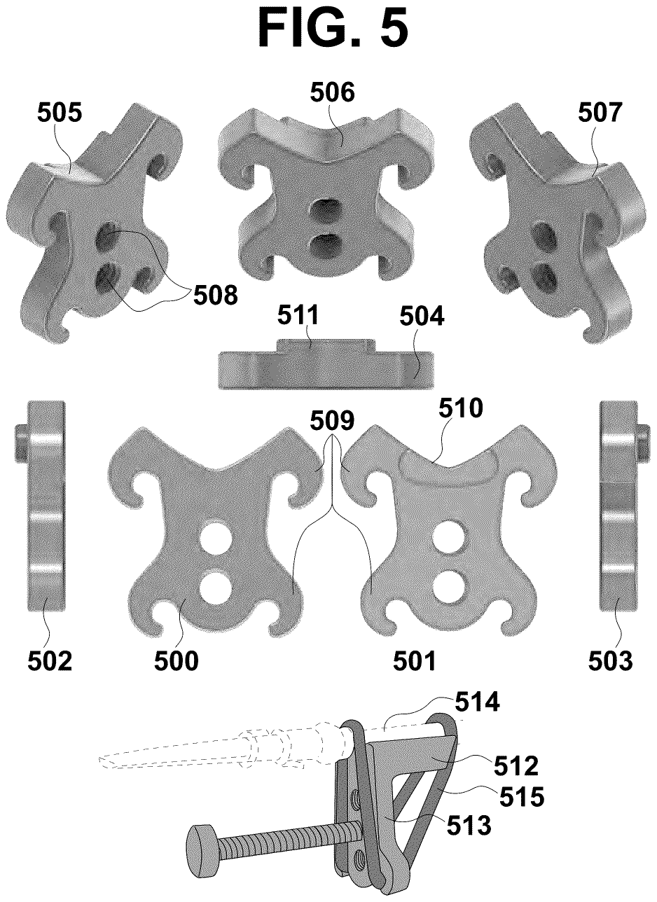

FIG. 5 Shows various isolated views of a training device brace. The brace is shown in front view 500, back view 501, left view 502, right view 503, top view 504, off axis top left view 505, off axis top center view 506, and an off axis top right view 507. Notice the elements of this embodiment including multiple screw holes 508 for varied screw heights along the brace, multiple brace hooks 509 located on opposing sides of the brace for varied hook length tension, and a concave mounting surface 510 where the brace mounts against varied diameter convex surfaces of musical instruments. Also shown in this embodiment is a protrusion 511 that extends and widens the concave mounting surface 510 to increase surface contact and mounting balance against a musical instrument. Protrusions such as 511 can be added to any portion of the brace to improve mounting options and surface contact. For example, at the bottom of FIG. 5 you can see protrusion 512 extending from brace 513 with the training device mounted against a bassoon reed and bocal 514 (drawn with dashed lines). This protruding extension allows for increased surface contact when mourning the brace and wider bracing tension of the elastic band 515. This protrusion 512 also gives the brace more concave mounting surface (not directly shown in this view but shown and discussed as 510) so the brace mates well against the convex tube of the bassoon bocal 514. Also notice how this embodiment for bassoon use includes brace hooks 516 as previously shown and discussed, plus a second set of brace hooks 517 located at the end of protrusion 512.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A wind instrument training device that is mountable to an instrument at or near the mouthpiece and is mechanically adjustable to create one or more physical touch points of the training device with the musician's face or body, the training device being made adjustable to accommodate a varied musical instrument sizes via the use of one or more looped elastic cords stretched so opposing ends of the looped elastic cord engage with one or more hooks to cause tension mounting of the training device against a musical instrument.

2. The training device of claim 1 wherein the the training device includes one or more concave mounting surfaces to mount against the surfaces of the wind instrument, and the training device having one or more screw mechanisms to adjust the one or more physical touch points of the training device in relation to the musician's face or body.
